(19) United States
(12) Patent Application Publication
(10) Pub. No.: US 2002/0097587 A1
(43) Pub. Date: Jul. 25, 2002

(54) Variable output laser illuminator and targeting device

(76) Inventors: Mark Howard Krietzman, Palos Verdes Estates, CA (US); Yu-Hsin Chen, Palos Verdes Estates, CA (US)

Correspondence Address: Mark H. Krietzman, P.O. BOX 3185, Palos Verdes, CA, 90274, US

(21) Appl. No.: 09/781,878

(22) Filed: Feb. 12, 2001

Related U.S. Application Data
(60) Provisional application No. 60/181,831, filed on Feb. 11, 2000.

(51) Int. Cl. F21V 7/04

(52) U.S. Cl. 362/553

(57) ABSTRACT

A laser illuminator which produces a diffuse coherent output. The energy of the diffuse output may be controlled with a variable current switch and a pinpoint targeting laser may be added to provide illumination and targeting capabilities.

### RELATED APPLICATIONS

The invention claims the benefit, under Title 35, United States Code 119(e), of Provisional Application, No. 60/181831, filed Feb. 11, 2000, entitled “High Output Laser Illuminator”.

### BACKGROUND OF THE INVENTION

1. Field of the Invention

This present invention relates to laser powered illumination devices, and more particularly to a portable laser illuminator with a variable power diffuse laser output well-suited for illumination and which may also include a pinpoint laser output for targeting.

2. Related Art

High power laser emitting sources can provide a collimated substantially coherent spot or a narrow flood over greater distances than a similar size incoherent flashlight. However, eye safety must be balanced against the efficiency of using a narrow wavelength coherent light source. One set of guidelines for classifying laser devices for consumer use which considers eye-safety is codified at 21 C.F.R. § 1040.10-11. While there may be situations such as those mentioned in U.S. Pat. No. 5,997,163, issued to Brown, in which visually stunning a person for military or police safety may be desirable—for the most part it is advantageous when using a laser illuminator to control the intensity of laser emissions; ideally initially at a lower intensity, which the operator can then “turn-up” as appropriate, which would include turning up to a stunning intensity.

In Applicant Krietzman.'s U.S. Pat. No. 6,000,813, which pre-dates the filing of Brown, Applicant was developing illumination devices using diffuse laser output, further development on laser illuminator by Applicants yielded the current invention with its safety features.

The present invention provides a laser illuminator with diffusion elements and current limiting controls to “ramp-up” the laser output—rather that constantly emit at the highest output levels. The present invention also provides a combination laser illuminator and targeting device wherein a laser output in one spectral range in used for the diffuse laser output and a targeting laser is included with a distinct spectral range is used.

Definitions:

The below defined terms shall be attributed the meaning set forth herein for claim interpretation and for the “doctrine of equivalents”.

A. The term “laser output” shall include, but not be limited to, the coherent light whether visible, non-visible, ultra-violet, infrared or x-ray, produced by a laser.

B. The term “diffuse” shall include, but not be limited to, the output resulting from directing the coherent light emitted by a laser through a lens, lenses, substrate, filter, grating or other material which results in a decrease in the degree of collimation of the coherent light.

C. The term “eye-safe” shall include, but not be limited to, those laser outputs and diffuse laser outputs which under 21 CFR 1040.10-11 meet the requirements to be classified as a class III laser emitting device.

D. The term “diffusion element” shall include, but not be limited to, beam expanders, convex lenses, concave lenses, conical lenses, magnifying lenses, condensing lenses, Fresnel lenses, diffusion lenses, interference pattern generating gratings, cross-hair generator lens, straight line generator lenses, pattern generator lenses, diffractive pattern generators, dichroic filters, holographic diffusers, diffractive optical diffusers, optical diffusion glass, optical diffusion plastic, diffusion filters, circular diffusers, elliptical diffusers, off-axis lenses, off-axis holographic filters, or off-axis holographic diffusers.

### SUMMARY OF INVENTION

The within invention is a sequential step building upon Applicant Krietzman's U.S. Pat. Nos. 6,000,813 and 6,062,702, this invention provides a diffuse laser illumination, the intensity of which is controlled via optical diffusion elements and variable current.

For a consumer type illuminator the diffusion elements may be permanently affixed to a enclosure with the lasing head to both prevent foreseeable misuse such as the dissociation from the device of a removable diffusion element and provide an eye-safe output. When used as an illuminator by making the “on/off” switch a “deadman” type switch requiring a positive force to be applied to keep it on and to increase the current the operator is guided into using the illuminator in the safest manner.

When used as a tactical illuminator a series of diffusion elements may be affixed to the device and a variable current switch may or may not be used depending on then intended use and type of laser output provided for illumination. When used as a combination illuminator and targeting device a second “targeting” laser which provides a pin-point laser output, is also affixed within the casing. When weapons mounted the spacial location of the targeting laser's output is adjustable in the “X” and “Y” axis via set screws through the casing.

The features of the invention believed to be novel are set forth with particularity in the appended claims. The invention itself, however, both as to configuration, and method of operation, and the advantages thereof, may be best understood by reference to the following descriptions taken in conjunction with the accompanying drawings.

### BRIEF DESCRIPTION OF TIRE DRAWINGS

FIG. 1A illustrates a cut-away side view of the preferred embodiment of the variable output laser illuminator and targeting device.

FIG. 1B illustrates a front view of the overlens of preferred embodiment.

FIG. 1C illustrates a partial perspective view of the laser illuminator with a lever type switch.

FIG. 1D illustrates a partial perspective view of the laser illuminator with a wheel type switch.

FIG. 1E illustrates a partial perspective view of the laser illuminator and targeting device.

FIG. 2A illustrates a cut-away side view of a first alternate embodiment of the diffusion laser module of the preferred embodiment.

FIG. 2B illustrates a cut-away side view of a second alternate embodiment of the diffusion laser module of the preferred embodiment.

FIG. 3A illustrates a circuit diagram for the laser illuminator embodiment.

FIG. 3B illustrates a circuit diagram for the laser illuminator and targeting device embodiment.

### MODES FOR CARRYING OUT THE INVENTION

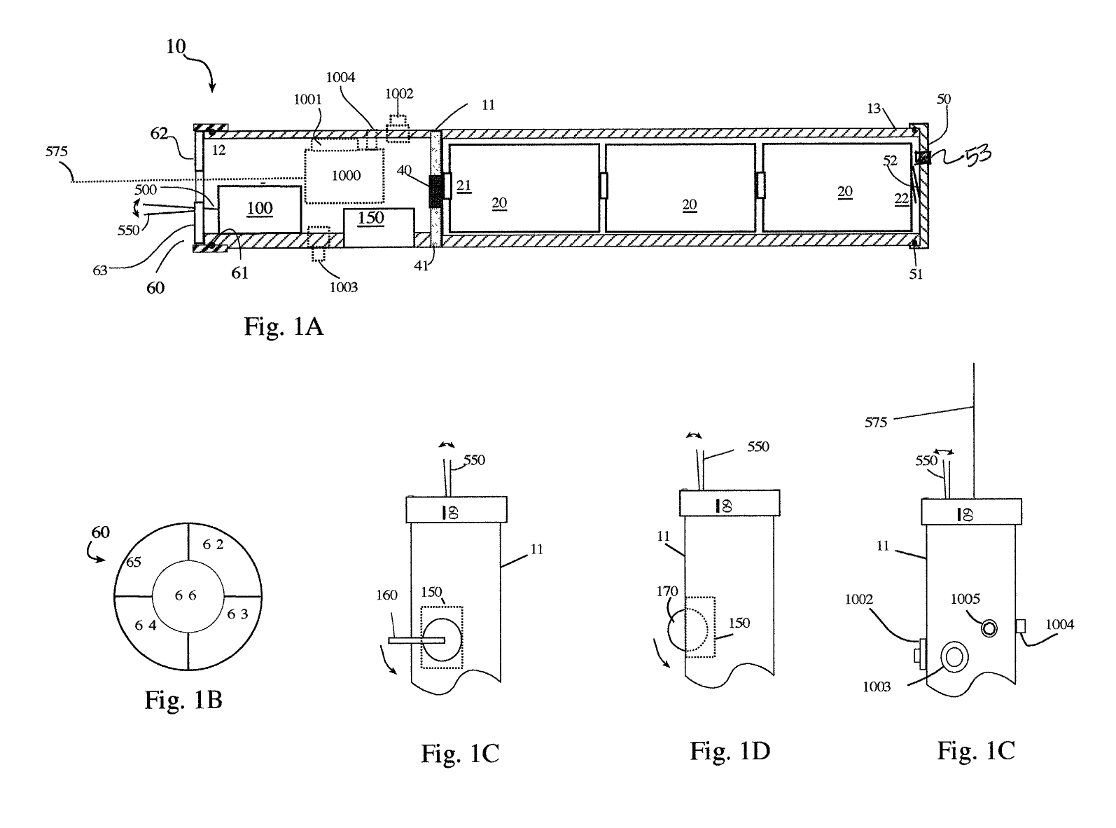

Shown in FIG. 1A is a cut-away side view of the variable output laser illuminator and/or targeting device, generally designated 10. Within a generally tubular conductive casing 11, which has an open front end 12 and an open back end 13, is mounted a diffusion laser emitting source 100 which includes a laser module with drive circuitry. The casing 11 is adapted to accept a replaceable battery power supply 20 through the back end 13. The first terminal 21 of the battery power supply abuts an internal contact 40 which is affixed through a non-conductive wall 41 affixed within the casing 11. A removable end cap 50 with an inset “O” ring 51 is removably mated to the back end 13. An internal spring contact 52 extending from the inner surface of the end cap 50 is conductively placed against second terminal 22 of the battery power supply thereby connecting the second terminal 22 to the conductive casing. A one-way valve 53 may be inserted through the casing 11 or end cap 50 to vent gases which may evolve during use and equalize pressure with in the casing.

FIG. 1B provides a front view of the removable overlens cover 60, with sealing “O” ring 61, which may be removably mated to the casing's front end 12. A series of diffusion elements 62-65 may be formed as part of, or affixed to, the overlens cover 60 blocking to the exit of unaltered diffusion laser output 500 from the casing and causing that unaltered diffusion laser output 500 to pass there-through resulting in the altered diffusion laser output 550. A clear window 66 may be formed in the overlens cover 60 to allow passage of the pin-point laser output 575 shown in FIG. 1E.

The diffusion elements in the preferred embodiment include holographic diffusers manufactured by Physical Optics Corporation located in Torrance Calif., or a diffractive optic diffuser manufactured by MEMS OPTICAL located in Huntsville Alabama, in either case with an angular divergence of between about 2 and 20 degrees with a square, rectangular, elliptical or round shape.

Other suitable diffusion elements, depending on the intended usage of the device, include beam expanders, convex lenses, concave lenses, conical lenses, magnifying lenses, condensing lenses, Fresnel lenses, diffusion lenses, interference pattern generating gratings, cross-hair generator lens, straight line generator lenses, pattern generator lenses, diffractive pattern generators, dichroic filters, optical diffusion glass, optical diffusion plastic, diffusion filters, circular diffusers, elliptical diffusers, off-axis lenses, off-axis holographic filters, or off-axis holographic diffusers all of which are within the intended scope of the invention. The foregoing list is not an exclusive list, it is merely provided to fulfill best mode requirements and in no way be should be construed to limit the application of the “doctrine of equivalent” to the invention claimed within.

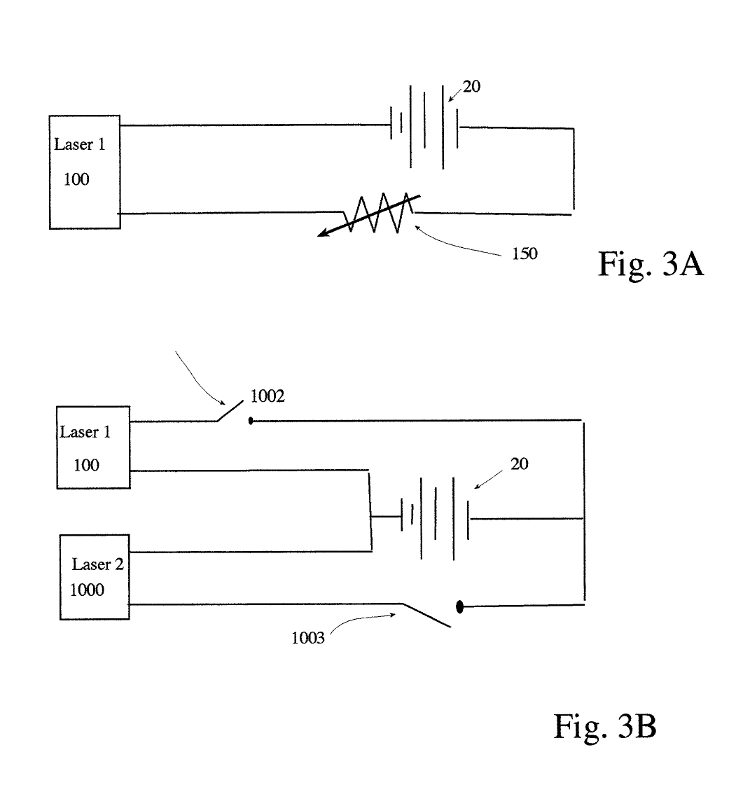

A variable current switch 150 which requires a constant positive pressure to switch “on” and maintain current to the diffusion laser emitting source 100 is also affixed within the casing 11 and is conductively linked to the battery power supply 20 (FIG. 3A). In FIG. 1C and 1D there are shown examples of alternate actuating elements for the variable current switch 150, which include a lever-type actuating arm 160 or a wheel-type 170 actuator. These actuators are provided to fulfill best mode requirements and in no way shall be construed as intended to limit the application of the “doctrine of equivalents” as applied to the “switch” element or to be the exclusive type of switch actuating elements within the scope of this invention. Further, other forms of variable current switches including slide switches, electronic switches, variable pressure switch and the like are suitable alternatives depending on the specific intended usage of the device.

A targeting laser emitting source 1000, which includes a laser module with drive circuitry, may be mounted in the casing on a movable mount 1001 to provide a pin-point laser output for targeting 575. When the targeting laser emitting source 1000 is added (FIG. 1E) and the device intended for use mounted to a weapon, the variable current switch 150 may be replaced with a click “on” click “off” switch 1002. A second click “on” click “off” 1003 is added to provided and conductively linked to the targeting laser emitting source 1000 (FIG. 3B). A pair of “X” and “Y” axis targeting laser adjustment set screws 1004 & 1005 are affixed through the casing 11 and used to adjust the orientation of the targeting laser emitting source 1000 when the device is mounted to a weapon (not shown).

The laser emitting sources 100 & 1000 and the variable current switch 150 are readily available and known art. The diode comprises a laser beam module with a control circuit. Since the laser emitting source and variable current switch are well known in the art, it is unnecessary to present a detailed statement of their construction in the present invention.

For the preferred embodiment one or more solid state laser emitting source in the visible range are used. For the targeting laser emitting source a corrective optic may be included to further collimate the quasi-collimated output produced by a solid-state diode. Diode-pumped, CW diode, Q-switched diode, solid-state, solid-state CW, solid-state Q-switched, gas, dye, ion, or rare-earth element, variable wavelength, tunable, frequency doubled, YAG, constant wave or pulsed laser emitting sources may be used in place of the solid state diode when appropriate for the intended usage without departing from the intended scope of the invention. For surveillance uses, search and rescue or other applications which use night vision or machine vision coupled with a non-visible spectrum illumination a laser emitting diode in the x-ray, ultraviolet or infrared spectrum may be substituted for the visible spectrum laser emitting diode(s).

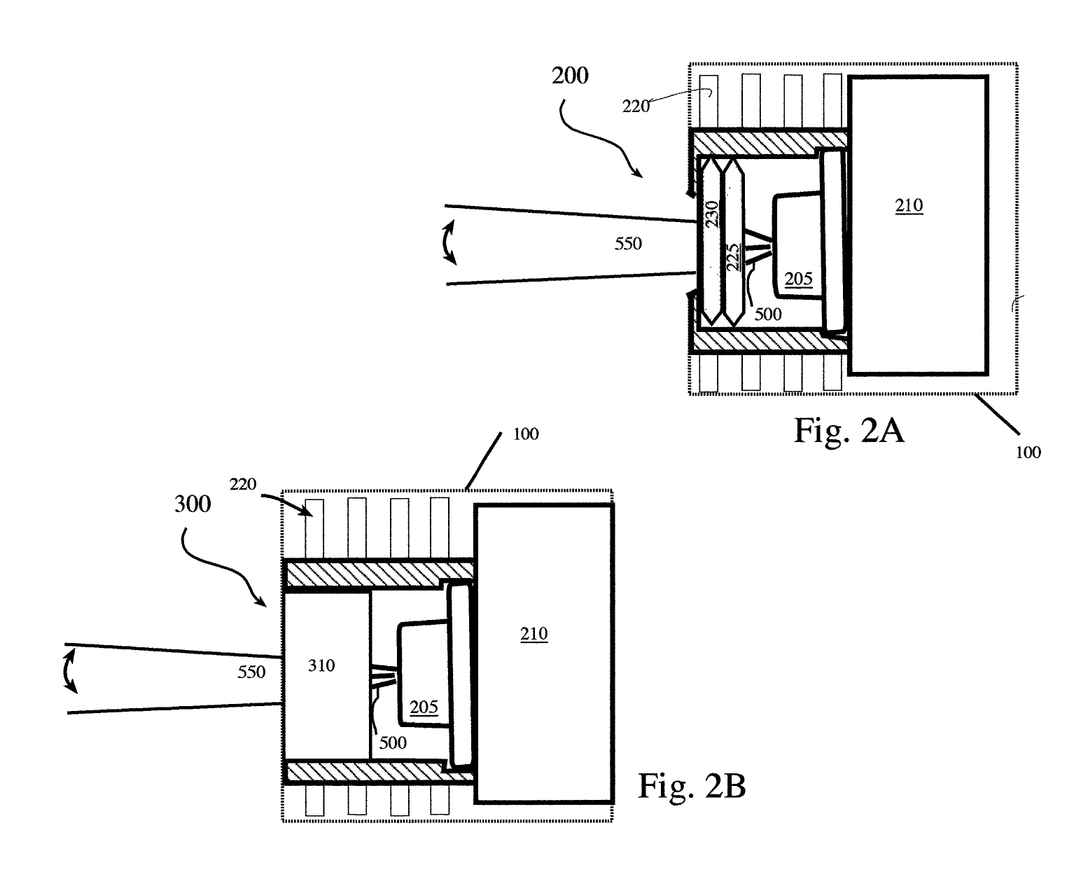

In FIGS. 2A and 2B a cut away view of two alternate embodiments for the diffusion laser emitting source 100 are shown, and generally designated 200 and 300. The diffusion laser emitting source includes a laser module 205 with drive circuitry 210 and may also include a heat sink 220. When current is provided the unaltered diffusion laser output 500 passes through either a group of optical elements 225 & 230 (FIG. 2A) or a single optical element 310 (FIG. 2B), resulting in the altered diffusion laser output 550. By permanently affixing the optical element(s) 225, 230 or 310 to the laser emitting source is useful for non-tactical applications and specifically for consumer use as an illuminator. The fixed optical elements address the foreseeable misuse be consumers of a high powered laser emitting source. The exact characteristics of the chosen optical element(s) 225, 230 or 310 is dependent on the characteristic of the diffusion laser emitting source. It is the energy of altered diffusion laser output 550 measured as specified in 21 CFR 1040.10-11 which provides the energy limits for a laser emitting device to be classified as a class III laser emitting device.

Materials for the diffusion elements, depending on the intended usage of the device, include beam expanders, convex lenses, concave lenses, conical lenses, magnifying lenses, condensing lenses, Fresnel lenses, diffusion lenses, interference pattern generating gratings, cross-hair generator lens, straight line generator lenses, pattern generator lenses, diffractive pattern generators, dichroic filters, holographic diffusers, diffractive optical diffusers, optical diffusion glass, optical diffusion plastic, diffusion filters, circular diffusers, elliptical diffusers, off-axis lenses, off-axis holographic filters, or off-axis holographic diffusers all of which are within the intended scope of the invention. The foregoing list is not an exclusive list, it is merely provided to fulfill best mode requirements and in no way be should be construed to limit the application of the “doctrine of equivalent” to the invention claimed within.

Since certain changes may be made in the above apparatus without departing from the scope of the invention herein involved, it is intended that all matter contained in the above description, as shown in the accompanying drawing, shall be interpreted in an illustrative, and not a limiting sense.

We claim:

1. A laser illuminator, comprising:
a tubular casing with an open front and rear;
a diffuse laser emitting source mounted within said casing;
an unaltered laser output exiting said diffuse laser emitting source;
one or more diffusion elements affixed in front of said laser emitting source, whereby said laser emission must pass through before exiting said casing;
an altered laser output exiting said casing after passing through said one or more diffusion elements;
a finger actuated current control switch to regulate the flow of current to said diffuse laser emitting source;
a battery power supply conductively linked to said current control switch to supply current to said diffuse laser emitting source; and,
a back cover adapted to removably mate with said open rear and hold said battery power supply within said casing.

2. The laser illuminator of claim 1 wherein said one or more diffusion elements are permanently affixed to said laser emitting source.

3. The laser illuminator of claim 1 further comprising a rotatable overlens, adapted to mate with said open front, to which said one or more diffusion elements are affixed.

4. The laser illuminator of claim 3 wherein each of said one or more diffusion elements provide a different alteration of said unaltered laser output as it passes there-through.

5. The laser illuminator of claim 1 wherein said one or more beam altering elements are selected from the group consisting of beam expanders, convex lenses, concave lenses, conical lenses, magnifying lenses, condensing lenses, Fresnel lenses, diffusion lenses, interference pattern generating gratings, cross-hair generator lens, straight line generator lenses, pattern generator lenses, diffractive pattern generators, dichroic filters, holographic diffusers, optical diffusion glass, diffractive optical diffusers, optical diffusion plastic, diffusion filters, circular diffusers, elliptical diffusers, off-axis lenses, off-axis holographic filters, and off-axis holographic diffusers.

6. The laser illuminator of claim 1 wherein said finger actuated current control switch is selected from the group consisting of lever arms, wheels, sliding, and pressure switches.

7. The laser illuminator of claim 1 adapted to remain operable when immersed in a liquid.

8. A laser illuminator and targeting device comprising:
a tubular casing with an open front and rear;
a diffuse laser emitting source mounted within said casing;
an unaltered laser output exiting said diffuse laser emitting source;
one or more diffusion element affixed in front of said laser emitting source whereby said laser emission must pass through-through before exiting said casing;
an altered laser output exiting said casing after passing through said at least one diffusing element;
a targeting laser emitting source adjustable mounted within said casing;
a pin-point targeting laser output;
a first “on/off” switch to provide current to said diffuse laser emitting source;
a second “on/off” switch to provide current to said targeting laser emitting source;
a battery power supply conductively linked to said first and second “on/off” switches; and,
a back cover adapted to removably mate with said open rear and hold said battery power supply within said casing.

9. The device of claim 8 wherein said one or more diffusion element is permanently affixed to said laser emitting source.

10. The device of claim 8 further comprising a rotatable overlens, adapted to mate over said open front, to which said one or more diffusion elements are affixed.

11. The device of claim 8 wherein said one or more beam altering elements are selected from the group consisting of beam expanders, convex lenses, concave lenses, conical lenses, magnifying lenses, condensing lenses, Fresnel lenses, diffusion lenses, interference pattern generating gratings, cross-hair generator lens, straight line generator lenses, pattern generator lenses, diffractive pattern generators, dichroic filters, holographic diffusers, optical diffusion glass, diffractive optical diffusers, optical diffusion plastic, diffusion filters, circular diffusers, elliptical diffusers, off-axis lenses, off-axis holographic filters, and off-axis holographic diffusers.

12. The device of claim 8 adapted to remain operable when immersed in a liquid.

13. The device of claim 8 further comprising:
a first set screw extending through said casing and adapted to displace said targeting laser emitting source in a predetermined amount corresponding to the movement of said first set screw; and,
a second set screw extending through said casing at about 90 degrees relative to said first set screw and adapted to displace said targeting laser emitting source, in a predetermined amount corresponding to the movement of said second set screw.

14. The device of claim 13, adapted to mount onto a weapon.

15. The device of claim 13 wherein said altered laser output is substantially in one spectral region and said pin-point targeting laser output is substantially in a different spectral region.

16. The device of claim 13 wherein said altered laser output is substantially in the blue/green spectral region and said pin-point targeting laser output is substantially in the red spectral region.

17. A method of laser illumination comprising the steps of:
placing a laser emitting source with a variable current “on/off” switch and power supply within a casing;
switching “on” said laser emitting source;
directing the laser output produced by said laser emitting source through a diffusion element;
directing the diffuse laser output exiting the diffusion element at a target;
incrementally increasing the current supplied said laser emitting source via said variable current switch; and,
continuing to direct said diffuse laser output at a target.
